(19) United States
(12) Patent Application Publication
(10) Pub. No.: US 2024/0152565 A1
(43) Pub. Date: May 9, 2024

(54) INFORMATION PROCESSING SYSTEM, INFORMATION PROCESSING METHOD AND INFORMATION PROCESSING PROGRAM

(71) Applicant: National Institute of Information and Communications Technology, Tokyo (JP)

(72) Inventors: Kentaro Torisawa, Koganei-shi, Tokyo (JP); Kiyonori Otake, Koganei-shi, Tokyo (JP)

(21) Appl. No.: 18/281,902

(22) PCT Filed: Feb. 15, 2022
(86) PCT No.: PCT/JP2022/005868

§ 371 Date: Sep. 13, 2023

(30) Foreign Application Priority Data
Mar. 31, 2021 (JP) 2021-061285

(51) Int. Cl. G06F 16/9537; G06F 16/23; G06F 16/903; G06F 16/9536

(52) U.S. Cl. CPC G06F 16/9537; G06F 16/2365; G06F 16/90344; G06F 16/9536

(57) ABSTRACT

An information processing system includes a processing result database that stores a processing result of a processing target including location information. One or more processors determine a unit area corresponding to the location information included in the processing target. The processors analyze the text through any of analysis processes including a first analysis process and a second analysis process higher in accuracy than the first analysis process. When a processing result of another processing target for the determined unit area has been already stored after obtaining a first processing result by analyzing the text through the first analysis process, the processors add the first processing result to the processing result database. When the processing result of the other processing target has not been stored, the processors obtain a second processing result by analyzing the text through the second analysis process and store the same into the processing result database.

### TECHNICAL FIELD

The present invention relates to an information processing system, an information processing method, and an information processing program.

### BACKGROUND ART

With rapid spread of mobile terminals such as smartphones, SNS (Social Networking Service) has been used for various purposes as means by which anyone can readily provide information. As one of purposes of use of the SNS, information collection at the time of disaster is drawing attention.

Information that should be collected at the time of disaster includes a detail of an event having occurred, a location of occurrence of the event, and the like. On the other hand, from a viewpoint of protecting privacy and personal information of a person who provides information, the following method is employed: location information possessed by a mobile terminal of the person who provides information is not used and only a location of interest is specified by only analyzing an expression indicating the location explicitly provided by the user.

Natural language processing is used to analyze a text included in a message and extract the detail of the event. For example, higher accuracy can be achieved by utilizing a language model according to deep learning as disclosed in Jacob Devlin, Ming-Wei Chang, Kenton Lee, and Kristina Toutanova, “BERT: Pre-training of Deep Bidirectional Transformers for Language Understanding,” Proceedings of NAACL-HLT 2019, pages 4171-4186.

In order to implement a language analysis process according to deep learning, it is necessary to perform an enormous amount of calculation both at the time of training and at the time of execution, and a dedicated hardware resource such as a GPU (Graphics Processing Units) or a neurochip is often used. Therefore, when such a language analysis process according to deep learning is employed, cost is increased as compared with a case where it is implemented using a general-purpose hardware resource such as a CPU (Central Processing Unit).

Particularly, at the time of disaster or the like, a large amount of information is provided and therefore it is necessary to process an enormous amount of text, whereas there is such a demand that an analysis process must be completed within a limited processing time because it is necessary to immediately take a measure or countermeasure.

### SUMMARY OF THE DISCLOSURE

It is one object of the present invention to provide a technique for efficiently processing a processing target including location information and a text.

An information processing system according to an embodiment includes: a processing result database that stores a processing result of a processing target including location information and a text; area determining means for determining a unit area corresponding to the location information included in the processing target; and analyzing means for analyzing the text through an analysis process designated from among a plurality of analysis processes including a first analysis process and a second analysis process higher in accuracy than the first analysis process, and for outputting the processing result; and control means for, when a processing result of another processing target for the determined unit area has been already stored after obtaining a first processing result by analyzing the text through the first analysis process, adding the first processing result to the processing result database, and when the processing result of the other processing target for the determined unit area has not been stored after obtaining the first processing result by analyzing the text through the first analysis process, obtaining a second processing result by analyzing the text through the second analysis process and storing the second processing result into the processing result database.

The plurality of analysis processes may further include a third analysis process higher in accuracy than the first analysis process and lower in accuracy than the second analysis process. In a load state in which the second analysis process is unable to be performed, the control means may analyze the text through the third analysis process instead of the second analysis process.

The processing result may include a phrase that is a character string indicating information that should be extracted, and semantic information indicating a meaning of the phrase.

The information management system may further include a processing state database that stores a processing state of an analysis process for each unit area. The processing state may be settable to any one of a state in which an analysis process has been performed and a processing result has been obtained, a state in which an analysis process has been performed and no processing result has been obtained, and a state in which no analysis process has been performed yet.

The processing state may include information that specifies a type of the analysis process performed. The control means may additionally perform an analysis process higher in accuracy than the analysis process used to obtain the processing result of any unit area.

When the processing state of the determined unit area does not exist in the processing state database, the control means may search for a processing state for another unit area existing within a predetermined range from the determined unit area.

The control means may obtain the second processing result by analyzing the text through the second analysis process even when the first processing result is unable to be obtained through the first analysis process.

The location information may include at least one of location information represented by latitude and longitude and location information represented by a UTM (Universal Transverse Mercator) coordinate system.

An information processing method according to another embodiment includes: receiving a processing target including location information and a text; determining a unit area corresponding to the location information included in the processing target; obtaining a first processing result by analyzing the text through a first analysis process; determining whether or not a processing result of another processing target for the determined unit area has been already stored in a processing result database; when the processing result of the other processing target for the determined unit area has been already stored in the processing result database, adding the first processing result to the processing result database; and when the processing result of the other processing target for the determined unit area has not been stored in the processing result database, obtaining a second processing result by analyzing the text through a second analysis process higher in accuracy than the first analysis process, and storing the second processing result into the processing result database.

According to still another aspect, there is provided an information processing program for causing a computer to perform the information processing method.

According to the present invention, it is possible to efficiently process a processing target including location information and a text.

### BRIEF DESCRIPTION OF DRAWINGS

FIG. 1 is a schematic diagram showing an exemplary system configuration of an information processing system according to the present embodiment.

FIG. 2 is a schematic diagram showing exemplary interaction between a user of a mobile terminal and a chatbot shown in FIG. 1.

FIG. 3 is a schematic diagram showing an exemplary hardware configuration of an analysis device included in the information processing system according to the present embodiment.

FIG. 4 is a schematic diagram showing an analysis process provided by the information processing system according to the present embodiment.

FIG. 5 is a schematic diagram showing an exemplary processing result database generated by the information processing system according to the present embodiment.

FIG. 6 is a schematic diagram showing another exemplary processing result database generated by the information processing system according to the present embodiment.

FIG. 7 is a schematic diagram showing an exemplary processing state database generated by the information processing system according to the present embodiment.

FIG. 8 is a diagram showing an exemplary difference between processing results due to a difference between analysis process programs in the information processing system according to the present embodiment.

FIG. 9 is a flowchart showing an exemplary processing procedure of the analysis process provided by the information processing system according to the present embodiment.

### DETAILED DESCRIPTION OF EMBODIMENTS

Embodiments of the present invention will be described in detail with reference to figures. It should be noted that the same or corresponding portions in the figures are denoted by the same reference characters and will not be described repeatedly.

### A. SYSTEM CONFIGURATION

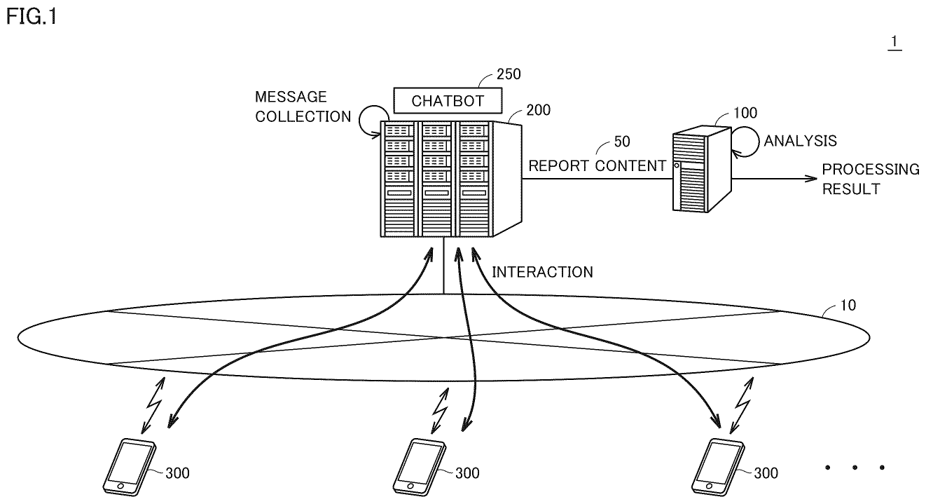

FIG. 1 is a schematic diagram showing an exemplary system configuration of an information processing system 1 according to the present embodiment. Referring to FIG. 1, information processing system 1 includes an analysis device 100 and an SNS server 200. It should be noted that for convenience of explanation, it will be illustratively described that analysis device 100 and SNS server 200 are separated from each other, but they may be incorporated with each other.

SNS server 200 collects a message exchanged with a mobile terminal 300. It should be noted that the message may include any content such as a still image, or a video image in addition to text.

SNS server 200 has a chatbot 250. Chatbot 250 behaves as an imaginary user of the SNS and interacts with a user of mobile terminal 300 to collect a message from the user. Typically, chatbot 250 performs interaction to collect information (hereinafter, also referred to as “report content”) in the case of occurrence of disaster.

Analysis device 100 analyzes report content 50 generated from one or a plurality of messages collected in SNS server 200 by chatbot 250 or the like, and outputs a processing result (processing result 71 described later). For example, the processing result includes information such as an event having occurred and a location of occurrence of the event.

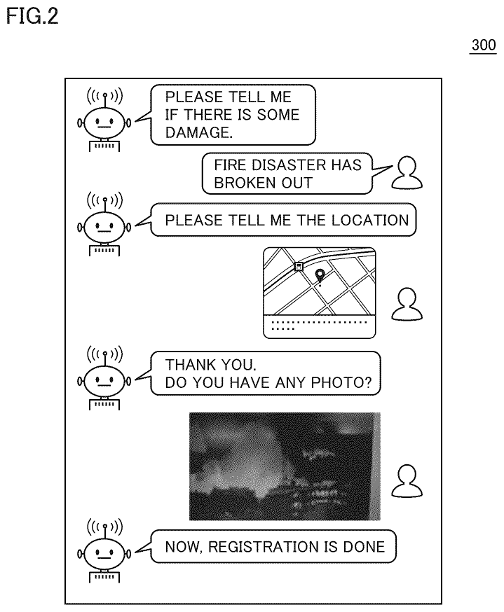

FIG. 2 is a schematic diagram showing exemplary interaction between the user of mobile terminal 300 and chatbot 250 shown in FIG. 1. Referring to FIG. 2, in response to a message from the user of mobile terminal 300, chatbot 250 transmits a message for prompting an input or a message for making an additional inquiry.

The user of mobile terminal 300 reports a situation, damage or the like caused by the disaster. At the time of this report, any text indicating details of the situation or damage, location information (for example, latitude/longitude information) related to the report, a still image or video image indicating the situation or damage, or the like is transmitted. It should be noted that the still image, the video image, or the like may not be attached. By the interaction as shown in FIG. 2, report content 50 is collected in SNS server 200.

In information processing system 1 according to the present embodiment, report content 50 including the location information and the text is a processing target. That is, as a whole process performed by information processing system 1, a processing result obtained by processing the location information and the text is stored into a database or the like (processing result database 70 and processing state database 80 described later). More specifically, as shown in FIGS. 1 and 2, for example, information processing system 1 extracts information by analyzing report content 50 (typically, the report of damage at the time of disaster) collected by chatbot 250 on the SNS, and stores, into the database, the information obtained by the extraction.

Typically, a character string (phrase 74 described later) describing necessary information is output as a text processing result. It should be noted that the output character string can include not only the information included in the text but also information indicating some meaning determined with reference to a dictionary or the like, a predetermined symbol, or the like.

Based on the information included in the output character string, it is possible to define a semantic distance between character strings or a determination procedure as to whether or not the character strings have the same meaning. Further, analysis device 100 extracts, as a semantic flag (corresponding to phrase type 75 and semantic category 76 described later), a partial character string used to find a semantic distance or the like in the character string. The semantic flag corresponds to semantic information indicating the meaning of the character string (phrase 74).

### B. EXEMPLARY HARDWARE CONFIGURATION

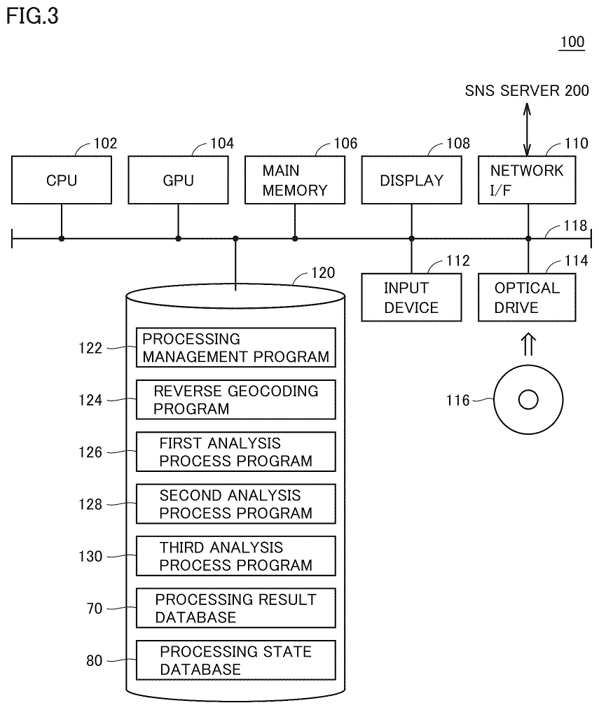

FIG. 3 is a schematic diagram showing an exemplary hardware configuration of analysis device 100 included in the information processing system according to the present embodiment. Typically, analysis device 100 can be implemented using a general-purpose computer.

Referring to FIG. 3, analysis device 100 includes a CPU 102, a GPU 104, a main memory 106, a display 108, a network interface (I/F) 110, an input device 112, an optical drive 114, and a secondary storage device 120 as main hardware components. These components are connected together via an internal bus 118.

CPU 102 and/or GPU 104 are processors that each perform an information processing method according to the present embodiment. A plurality of CPUs 102 and a plurality of GPUs 104 may be disposed, or each of CPU 102 and GPU 104 may have a plurality of cores.

Main memory 106 is a storage area that temporarily stores (or caches) a program code, work data, or the like when the processor (CPU 102 and/or GPU 104) performs a process, and is constituted of a volatile memory device or the like such as a DRAM (Dynamic Random Access Memory) or an SRAM (Static Random Access Memory), for example.

Display 108 is a display unit that outputs a user interface regarding a process, a processing result, or the like, and is constituted of, for example, an LCD (liquid crystal display), an organic EL (Electroluminescence) display, or the like.

Network interface 110 exchanges data with any information processing device or the like on the Internet or an intranet. In the present embodiment, network interface 110 serves to transfer report content 50 from SNS server 200 to analysis device 100. For network interface 110, any communication method can be employed such as Ethernet (registered trademark), wireless LAN (local area network), Bluetooth (registered trademark), or the like, for example.

Input device 112 is a device that receives an instruction, operation or the like from a user, and is constituted of, for example, a keyboard, a mouse, a touch panel, a pen, or the like.

Optical drive 114 reads out information stored in an optical disk 116 such as a CD-ROM (compact disc read only memory) or a DVD (digital versatile disc), and outputs the information to another component via internal bus 118. Optical disk 116 is an exemplary non-transitory recording medium, and is distributed with any program being stored therein in a non-volatile manner. When optical drive 114 reads out the program from optical disk 116 and installs the program into secondary storage device 120 or the like, the computer functions as analysis device 100. Thus, the subject matter of the present invention can be also the program itself installed in secondary storage device 120 or the like, or can be also a recording medium, such as optical disk 116, storing the program for implementing function and process according to the present embodiment.

FIG. 3 shows the optical recording medium such as optical disk 116 as the exemplary non-transitory recording medium; however, it is not limited thereto and a semiconductor recording medium such as a flash memory, a magnetic recording medium such as a hard disk or a storage tape, or a magneto-optical recording medium such as an MO (magneto-optical disk) may be used.

Secondary storage device 120 stores the program and data necessary for causing the computer to function as analysis device 100. For example, secondary storage device 120 is constituted of a non-volatile storage device such as a hard disk or an SSD (solid state drive).

More specifically, secondary storage device 120 stores: an OS (operating system) not shown; a processing management program 122 for managing execution of an analysis process; a reverse geocoding program 124 for determining a corresponding address from a geocode; and a first analysis process program 126, a second analysis process program 128, and a third analysis process program 130 each for implementing an analysis process. Further, processing result database 70 and processing state database 80 may be formed in secondary storage device 120.

FIG. 3 shows an example in which analysis device 100 is constructed using a single computer; however, it is not limited thereto, and a plurality of computers connected via a computer network may explicitly or implicitly cooperate together to implement the information processing method according to the present embodiment.

A whole or part of functions implemented by the processor (CPU 102 and/or GPU 104) executing the program may be implemented using a hard-wired circuit such as an integrated circuit. For example, a whole or part of the functions may be implemented using an ASIC (application specific integrated circuit), an FPGA (field-programmable gate array), or the like.

Those skilled in the art will be able to implement analysis device 100 according to the present embodiment by appropriately using a technique corresponding to an age in which the present invention is implemented.

### C. OUTLINE OF ANALYSIS PROCESS

Next, an analysis process provided by information processing system 1 according to the present embodiment will be outlined.

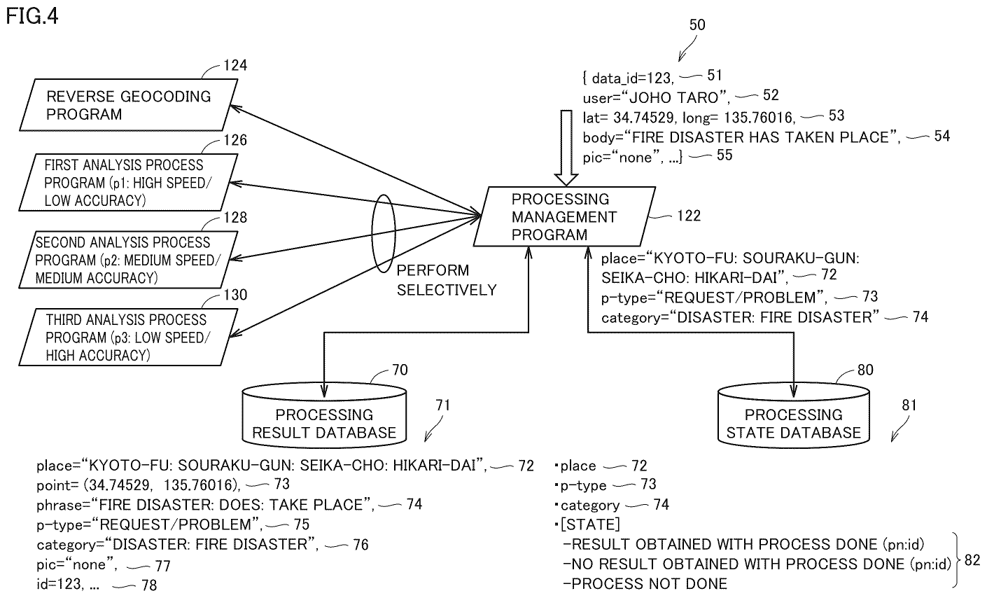

FIG. 4 is a schematic diagram showing the analysis process provided by information processing system 1 according to the present embodiment. Referring to FIG. 4, analysis device 100 analyzes report content 50 obtained from SNS server 200, and stores a processing result into each of processing result database 70 and processing state database 80. Analysis device 100 analyzes report content 50 including the location information (for example, latitude/longitude information) and the text at a higher speed.

SNS server 200 may provide report content 50 to analysis device 100 in, for example, a JSON format or XML format. Report content 50 may be provided to processing management program 122 via an API (Application Programming Interface) implemented on analysis device 100. Report content 50 includes, for example, identification information 51, user information 52, latitude/longitude information 53, text 54, and a photo attachment attribute 55.

For each report content 50, processing management program 122 selectively executes first analysis process program 126, second analysis process program 128, or third analysis process program 130 so as to generate a processing result 71. It should be noted that one or more of first analysis process program 126, second analysis process program 128, and third analysis process program 130 may be executed onto the same report content 50.

First analysis process program 126, second analysis process program 128, and third analysis process program 130 are different in terms of processing speed and accuracy. For example, first analysis process program 126 is relatively high in speed in processing but is relatively low in accuracy. Third analysis process program 130 is relatively low in processing speed but is relatively high in accuracy. The processing speed and accuracy of second analysis process program 128 are between those of first analysis process program 126 and those of third analysis process program 130, respectively.

Thus, information processing system 1 (analysis device 100) has analyzing means for analyzing text 54 included in report content 50 through an analysis process designated from among a plurality of analysis processes including an analysis process by first analysis process program 126 and an analysis process by third analysis process program 130 higher in accuracy than the analysis process by first analysis process program 126, and for outputting processing result 71. The plurality of analysis processes for the selection may include an analysis process by second analysis process program 128 that is higher in accuracy than the analysis process by first analysis process program 126 and lower in accuracy than the analysis process by third analysis process program 130.

Assuming a language analysis process, each of first analysis process program 126, second analysis process program 128, and third analysis process program 130 performs a process of analyzing the meaning of the text and outputting processing result 71. Although the respective manners of the analysis processes performed by the analysis process programs are different, the formats of output processing results 71 are configured to be the same.

For example, first analysis process program 126 extracts information in a rule-based manner, second analysis process program 128 extracts information using an SVM (Support Vector Machine), and third analysis process program 130 extracts information using deep learning.

It should be noted that it is not necessarily required to prepare the three types of analysis processes as shown in FIG. 4, and only two types of analysis processes may be prepared or a larger number of types of analysis processes may be prepared. That is, a plurality of types of analysis processes different in processing speed and accuracy are prepared, and these analysis processes are ordered based on a predetermined criterion.

Each of processing results 71 stored in processing result database 70 includes, for example, a unit area 72 corresponding to report content 50, latitude/longitude information 73 corresponding to report content 50, an extracted phrase 74, a phrase type 75 of extracted phrase 74, a semantic category 76 of extracted phrase 74, a photo attachment attribute 77 of corresponding report content 50, and identification information 78 of corresponding report content 50. Processing result 71 may be output as a character string in which all the pieces of information are collected.

Here, the “phrase” means a character string corresponding to information that should be collected from text 54 included in report content 50 (for example, expression of a situation or damage caused by disaster).

As a value of phrase type 75, for example, any one of “REQUEST/PROBLEM”, “CONTRADICTION”, and “COUNTERMEASURE” may be stored. As a value of semantic category 76, a text specifying details of the situation or damage caused by the disaster, such as “DAMAGE” or “FIRE DISASTER” is stored. Each of phrase type 75 and semantic category 76 corresponds to a semantic flag of report content 50.

Thus, processing result 71 includes: the character string (phrase 74) indicating the information that should be extracted; and the semantic flag (phrase type 75 and semantic category 76) that is the semantic information indicating the meaning of phrase 74.

When a plurality of phrases 74 are extracted from one report content 50, a character string in which a unit area 72, a phrase type 75, and a semantic category 76 are collected may be output for each extracted phrase 74. Further, when no phrase 74 is extracted from text 54 included in report content 50, a character string indicating that no phrase 74 has been extracted may be output.

Reverse geocoding program 124 corresponds to area determining means for determining a unit area corresponding to the location information included in report content 50 that is the processing target. More specifically, reverse geocoding program 124 outputs an address notation of unit area 72 corresponding to the location information (latitude/longitude information 53) included in report content 50. Granularity of unit area 72 output by reverse geocoding program 124 may be any granularity. For example, a town-district-based address notation may be used as the unit area, or a regional mesh such as a ½ regional mesh (quaternary mesh) may be used as the unit area. It should be noted that for the location information, not only the latitude/longitude expression format but also a UTM (Universal Transverse Mercator) coordinate system may be used. That is, the location information may include at least one of location information indicated by latitude and longitude, and location information indicated by the UTM coordinate system. Thus, the location information may be of any expression format as long as the location information is information by which any location on the ground can be specified.

Processing state database 80 stores a processing state 81 of an analysis process at least for each unit area. Each processing state 81 stored in processing state database 80 indicates a processing status of the analysis process for report content 50. More specifically, an execution state value 82 is stored in processing state database 80 as processing state 81 for each combination of unit area 72, phrase type 75, and semantic category 76.

One of the following states is settable to processing state 81 as execution state value 82: a “state in which an analysis process has been performed and a processing result has been obtained”; a “state in which an analysis process has been performed and no processing result has been obtained”, and a “state in which no analysis process has been performed yet”.

More specifically, execution state value 82 may store one of “RESULT OBTAINED WITH PROCESS DONE (pn:id)”, “NO RESULT OBTAINED WITH PROCESS DONE (pn:id)”, or “PROCESS NOT DONE”. “RESULT OBTAINED WITH PROCESS DONE (pn:id)” and “NO RESULT OBTAINED WITH PROCESS DONE (pn:id)” mean that analysis process(es) for one or more report contents 50 have been performed. On the other hand, “PROCESS NOT DONE” means that no analysis process for report content 50 has been performed yet.

Processing state 81 includes information for specifying a type of the analysis process performed. More specifically, in “pn” set in execution state value 82 of processing state 81, information for specifying the executed analysis process program is stored, such as “p1”, “p2” or “p3”.

Processing state 81 further includes information for specifying the processing target of the analysis process. More specifically, identification information 51 for specifying target report content 50 is stored in “id” set in execution state value 82 of processing state 81.

Execution state value 82 can be used for a process of extracting a report content 50 that should be preferentially subjected to an analysis process, a process of extracting a report content 50 that should be subjected to an analysis process higher in accuracy, or the like.

### D. PROCESSING RESULT DATABASE 70 AND PROCESSING STATE DATABASE 80

Next, specific examples of processing result database 70 and processing state database 80 will be described.

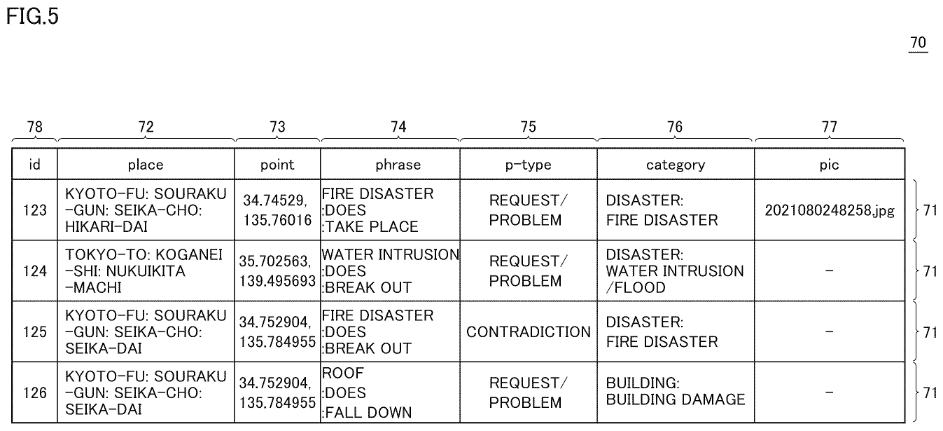

FIG. 5 is a schematic diagram showing an exemplary processing result database 70 generated by information processing system 1 according to the present embodiment. FIG. 5 shows an example in which processing result database 70 is implemented using a relational database.

Referring to FIG. 5, processing result database 70 has processing results 71 as entries, and each of processing results 71 is associated with identification information 78 (id). Processing result 71 includes unit area 72, latitude/longitude information 73, phrase 74, phrase type 75, semantic category 76, and photo attachment attribute 77.

By employing processing result database 70 using such a relational database, a flexible inquiry can be implemented using SQL.

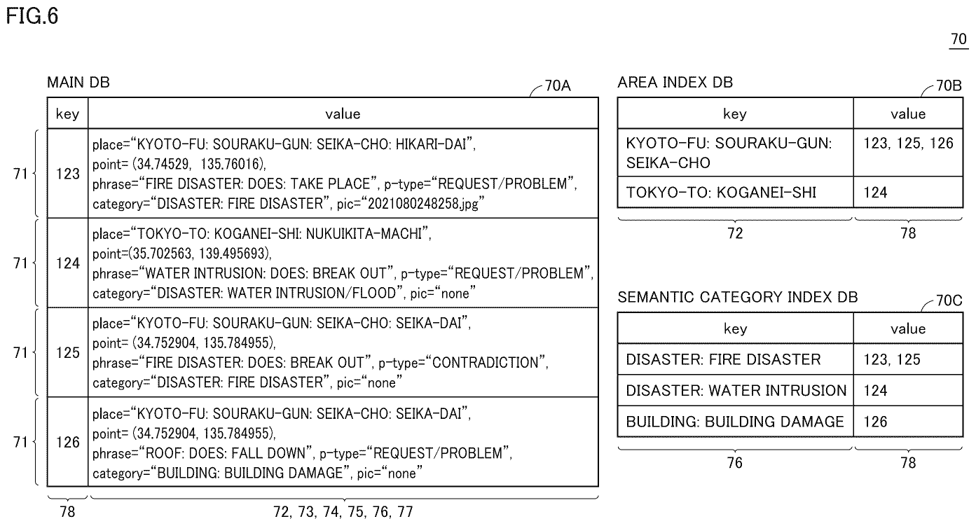

FIG. 6 is a schematic diagram showing another exemplary processing result database 70 generated by information processing system 1 according to the present embodiment. FIG. 6 shows an example in which processing result database 70 is implemented using a key-value store (KVS) database. In the key-value store database, an index corresponding to a key to be used for search is prepared in advance.

Referring to FIG. 6, processing result database 70 includes, for example, a main database 70A, an area index database 70B, and a category index database 70C.

Main database 70A has processing results 71 as entries. In each of processing results 71, identification information 78 is set as a key, and unit area 72, latitude/longitude information 73, phrase 74, phrase type 75, semantic category 76, and photo attachment attribute 77 are stored as a corresponding value.

In area index database 70B, unit area 72 is set as a key, and identification information 78 is stored as a value.

In category index database 70C, semantic category 76 is set as a key, and identification information 78 is stored as a value.

For example, for main database 70A, corresponding unit area 72, latitude/longitude information 73, phrase 74, phrase type 75, semantic category 76, and photo attachment attribute 77 can be searched for by designating identification information 78. For area index database 70B, corresponding identification information 78 can be searched for by designating unit area 72. For category index database 70C, corresponding identification information 78 can be searched for by designating semantic category 76.

By collectively calculating the search results of the plurality of index databases, a search including a logical calculation such as a logical sum or logical product can be implemented. In the example shown in FIG. 6, index search is performed using area index database 70B and/or category index database 70C to obtain a collection of identification information 78 (id), and a target processing result 71 is obtained from main database 70A using the obtained collection of identification information 78 (id).

By using such a key-value store database, high-speed search can be implemented.

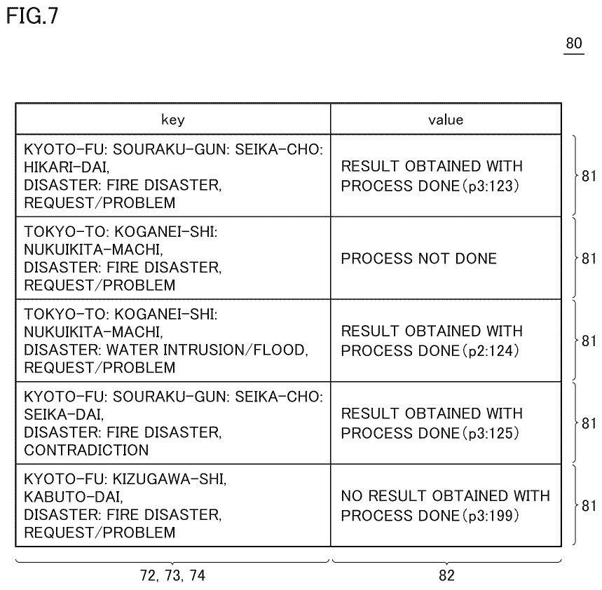

FIG. 7 is a schematic diagram showing an exemplary processing state database 80 generated by information processing system 1 according to the present embodiment. FIG. 7 shows an example in which processing state database 80 is implemented using a key-value store database.

Referring to FIG. 7, processing state database 80 has processing states 81 as entries. In each of the processing states 81, a combination of unit area 72, phrase type 75, and semantic category 76 is set as a key, and execution state value 82 is stored as a corresponding value.

It should be noted that it is not limited to the implementation of the database shown in each of FIGS. 5 to 7, and any implementation can be employed.

### E. DIFFERENCE IN ACCURACY BETWEEN ANALYSIS PROCESS PROGRAMS

Next, a difference in accuracy between the plurality of analysis process programs will be described.

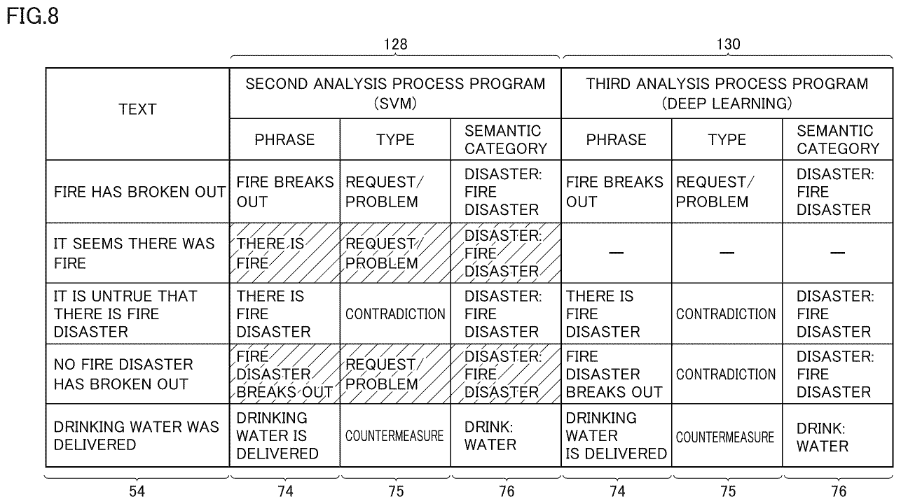

FIG. 8 is a diagram showing an exemplary difference between the processing results due to a difference between the analysis process programs in information processing system 1 according to the present embodiment. FIG. 8 shows exemplary respective processing results obtained by performing the analysis process by second analysis process program 128 (SVM) and the analysis process by third analysis process program 130 (deep learning) onto the same texts 54.

It should be noted that as each exemplary processing result, it will be illustratively described that phrase 74, phrase type 75, and semantic category 76 are output; however, it is not limited thereto and a larger number of pieces of information may be output.

For a text 54 “IT SEEMS THERE WAS FIRE” among five texts 54 shown in FIG. 8, second analysis process program 128 extracts a phrase 74 “THERE IS FIRE” and outputs a phrase type 75 and a semantic category 76 each corresponding to extracted phrase 74. On the other hand, third analysis process program 130 does not extract phrase 74. This is because third analysis process program 130 determines that such uncertain information “IT SEEMS THERE WAS FIRE” is not information that should be collected, and the processing result of third analysis process program 130 is correct for information processing system 1.

For a text 54 “NO FIRE HAS BROKEN OUT”, second analysis process program 128 extracts a phrase 74 “FIRE BREAKS OUT” and outputs a phrase type 75 “REQUEST/PROBLEM” and a semantic category 76 “DISASTER: FIRE DISASTER” so as to correspond to extracted phrase 74. On the other hand, third analysis process program 130 extracts the same phrase 74 “FIRE BREAKS OUT”, and outputs a phrase type 75 “CONTRADICTION” and a semantic category 76 “DISASTER: FIRE DISASTER” so as to correspond to extracted phrase 74. Since text 54 “NO FIRE HAS BROKEN OUT” does not indicate that fire has actually has broken out, the “CONTRADICTION” output by third analysis process program 130 is a correct processing result as the value of phrase type 75.

Thus, third analysis process program 130 can achieve higher accuracy than second analysis process program 128 (and first analysis process program 126). However, a larger amount of processing time and a larger number of resources are required.

### F. DETAILS OF ANALYSIS PROCESSES

Next, a more detailed processing procedure of the analysis process provided by information processing system 1 according to the present embodiment will be described.

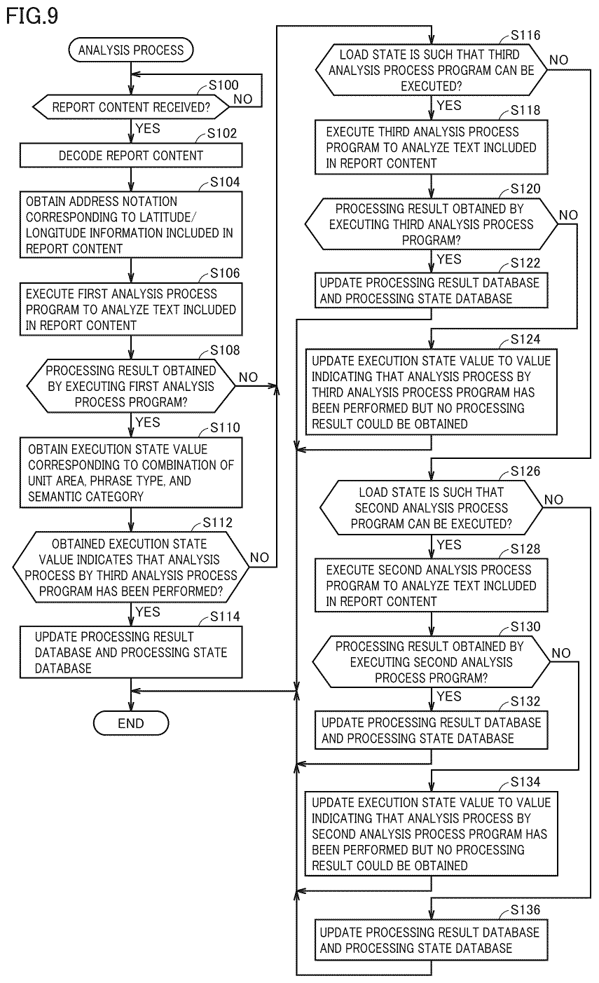

FIG. 9 is a flowchart showing an exemplary processing procedure of the analysis process provided by information processing system 1 according to the present embodiment. Each step shown in FIG. 9 is typically implemented by the processor (CPU 102 and/or GPU 104) of analysis device 100 executing a program including processing management program 122.

Referring to FIG. 9, analysis device 100 executes a process of receiving a report content 50 that is a processing target including location information and a text. More specifically, analysis device 100 determines whether or not report content 50 is received from SNS server 200 (step S100). When report content 50 is not received from SNS server 200 (NO in step S100), the process of step S100 is repeated.

When report content 50 is received from SNS server 200 (YES in step S100), analysis device 100 decodes report content 50 so as to handle it as an internal variable of the program (step S102). For example, when report content 50 in the JSON format is received, values are stored in the following variables (character strings starting with $).
$latlong=“(34.74529, 135.76016)”
$text=“FIRE DISASTER HAS TAKEN PLACE”
$pic=“none”

Then, analysis device 100 performs a process of determining a unit area corresponding to the location information included in report content 50 that is the processing target. More specifically, analysis device 100 executes reverse geocoding program 124 to obtain an address notation corresponding to latitude/longitude information 53 (value of $latlong) included in report content 50 (step S104). For example, when latitude/longitude information 53 indicates (34.74529, 135.76016), an address notation “KYOTO-FU, SOURAKU-GUN, SEIKA-CHO, HIKARI-DAI, 3 CHO-ME” is obtained. The obtained address notation serves as unit area 72.

Then, analysis device 100 performs a process of obtaining a processing result by analyzing the text through the analysis process lowest in accuracy (fastest in processing speed). More specifically, analysis device 100 executes first analysis process program 126 to analyze text 54 (value of $text) included in report content 50 (step S106).

For example, the following processing result is obtained for text 54 “FIRE DISASTER HAS TAKEN PLACE”.
Phrase 74: “FIRE DISASTER: DOES: TAKE PLACE”
Phrase type 75: “REQUEST/PROBLEM”
Semantic category 76: “DISASTER: FIRE DISASTER”

Then, analysis device 100 determines whether or not the processing result has been obtained by executing first analysis process program 126 (step S108). When the processing result has not been obtained (NO in step S108), processes in a step S116 and subsequent steps are performed. That is, even when the processing result cannot be obtained through the analysis process by first analysis process program 126, analysis device 100 obtains a processing result by analyzing text 54 through the analysis process by third analysis process program 130 (or second analysis process program 128) as described later.

When the processing result has been obtained (YES in step S108), analysis device 100 makes reference to processing state database 80 so as to obtain an execution state value 82 corresponding to a combination of unit area 72 obtained in step S104, phrase type 75 included in the obtained processing result, and semantic category 76 included in the obtained processing result (step S110). That is, analysis device 100 searches for a corresponding processing state 81 from processing state database 80 using unit area 72 and the semantic flag (phrase type 75 and semantic category 76) as a key.

In the above-described example, unit area 72 is “KYOTO-FU: SOURAKU-GUN: SEIKA-CHO: HIKARI-DAI”, phrase type 75 is “REQUEST/PROBLEM”, and semantic category 76 is “DISASTER: FIRE DISASTER”. Execution state value 82, which is a corresponding value, is searched for using a combination of these three values as a key.

It should be noted that when there is no entry that completely matches with unit area 72 and the semantic flag, the search target may be extended to a range that can be regarded as the same value such as another unit area existing within a predetermined range from target unit area 72 and/or another semantic flag existing at a predetermined semantic distance. Thus, when processing state 81 for determined unit area 72 does not exist in processing state database 80, analysis device 100 may search for a processing state 81 for another unit area 72 existing within the predetermined range from determined unit area 72.

Then, analysis device 100 determines whether or not the processing result of the other processing target (report content 50) for the determined unit area has been already stored in processing result database 70. More specifically, analysis device 100 determines whether or not obtained execution state value 82 indicates that the analysis process by third analysis process program 130 has been performed (step S112). In the above example, analysis device 100 determines whether or not corresponding execution state value 82 is “RESULT OBTAINED WITH PROCESS DONE (p3)”.

When obtained execution state value 82 indicates that the analysis process by third analysis process program 130 has been performed (YES in step S112), analysis device 100 updates processing result database 70 and processing state database 80 based on the information obtained in steps S104 and S106 (step S114). Then, the process is ended.

That is, when the processing result of the other processing target (report content 50) for the determined unit area has been already stored after obtaining the processing result by analyzing text 54 through the analysis process by first analysis process program 126, analysis device 100 adds the processing result by first analysis process program 126 to processing result database 70.

In this case, since it is indicated that the other report content 50 has been analyzed with regard to the combination of target unit area 72, phrase type 75, and semantic category 76 by third analysis process program 130 highest in accuracy, it is possible to determine that there is low necessity in further analyzing report content 50 received this time using another analysis process program, with the result that execution of the analysis process program higher in accuracy is skipped.

On the other hand, when obtained execution state value 82 does not indicate that the analysis process by third analysis process program 130 has been performed (NO in step S112), analysis device 100 determines whether or not a load state is such that third analysis process program 130 can be executed (step S116).

When the load state is such that third analysis process program 130 can be executed (YES in step S116), analysis device 100 executes third analysis process program 130 to analyze text 54 (value of $text) included in report content 50 (step S118). Then, analysis device 100 determines whether or not a processing result has been obtained by executing third analysis process program 130 (step S120).

When the processing result has been obtained (YES in step S120), analysis device 100 updates processing result database 70 and processing state database 80 based on the information obtained in steps S104 and S118 (step S122). Then, the process is ended.

That is, when the processing result of the other processing target (report content 50) for the determined unit area has not been stored after obtaining the processing result by analyzing text 54 through the analysis process by first analysis process program 126, analysis device 100 analyzes text 54 through the analysis process by third analysis process program 130 and obtains a processing result, and stores the processing result into processing result database 70.

On the other hand, when no processing result could be obtained (NO in step S120), analysis device 100 updates, to a value indicating that the analysis process by third analysis process program 130 has been performed but no processing result could be obtained, execution state value 82 corresponding to the combination of unit area 72 obtained in step S104, phrase type 75 included in the processing result obtained in step S106, and semantic category 76 included in the processing result obtained in step S106 (step S124). That is, as execution state value 82, “NO RESULT OBTAINED WITH PROCESS DONE (p3: target id)” is stored. Then, the process is ended.

It should be noted that when no processing result could be obtained in step S106, corresponding execution state value 82 cannot be specified and therefore the process of updating processing state database 80 in step S122 is skipped.

On the other hand, when the load state is not such that third analysis process program 130 can be executed (NO in step S116), analysis device 100 determines whether or not the load state is such that second analysis process program 128 can be executed (step S126).

When the load state is such that second analysis process program 128 can be executed (YES in step S126), analysis device 100 executes second analysis process program 128 to analyze text 54 (value of $text) included in report content 50 (step S128). Thus, in the load state in which the analysis process by third analysis process program 130 cannot be performed, analysis device 100 analyzes text 54 through the analysis process by second analysis process program 128 instead of third analysis process program 130.

Then, analysis device 100 determines whether or not a processing result has been obtained by executing second analysis process program 128 (step S130).

When the processing result has been obtained (YES in step S130), analysis device 100 updates processing result database 70 and processing state database 80 based on the information obtained in steps S104 and S128 (step S132). Then, the process is ended.

That is, when the processing result of the other processing target (report content 50) for the determined unit area has not been stored after obtaining the processing result by analyzing text 54 through the analysis process by first analysis process program 126, analysis device 100 obtains a processing result by analyzing text 54 through the analysis process by second analysis process program 128, and stores the processing result into processing result database 70.

On the other hand, when the processing result has not been obtained (NO in step S130), analysis device 100 updates, to a value indicating that the analysis process by second analysis process program 128 has been performed but no processing result could be obtained, execution state value 82 corresponding to the combination of unit area 72 obtained in step S104, phrase type 75 included in the processing result obtained in step S106, and semantic category 76 included in the processing result obtained in step S106 (step S134). That is, as execution state value 82, “NO RESULT OBTAINED WITH PROCESS DONE (p2: target id)” is stored. Then, the process is ended.

It should be noted that when no processing result could be obtained in step S106, corresponding execution state value 82 cannot be specified, and therefore the process of updating processing state database 80 in step S134 is skipped.

On the other hand, when the load state is not such that second analysis process program 128 can be executed (NO in step S126), analysis device 100 updates processing result database 70 and processing state database 80 based on the information obtained in steps S104 and S106 (step S136). Then, the process is ended.

The above-described processing procedure is repeatedly performed whenever a report content 50 is received. It should be noted that the above-described processing procedure is assumed to be executed in a parallel manner.

### G. EXEMPLARY OPERATION OF ANALYSIS PROCESS

In an actual operation, many of unit areas 72 registered in processing state database 80 are updated to “PROCESS DONE” with passage of time. As a result, since a frequency of performing the high-accuracy analysis process by third analysis process program 130 or the like can be decreased, an execution state value 82 corresponding to a combination of a unit area 72, a phrase type 75, and a semantic category 76 in a predetermined range registered in processing state database 80 may be initialized to “PROCESS NOT DONE” whenever a predetermined time (for example, 24 hours) passes or whenever a predetermined condition (for example, 80% of registered unit areas 72 are “PROCESS DONE”) is satisfied.

Further, there may be a case where high accuracy is not required for a specific semantic category 76 and/or a specific phrase type 75 and a high-accuracy analysis process is desired to be performed for those other than specific semantic category 76 and/or specific phrase type 75. For such a demand, an execution state value 82 corresponding to the combination of specific semantic category 76 and/or specific phrase type 75 may be initialized to “RESULT OBTAINED WITH PROCESS DONE” for all the unit areas registered in processing state database 80. When execution state value 82 is set to “RESULT OBTAINED WITH PROCESS DONE”, a report content 50 corresponding to the corresponding combination is always processed by first analysis process program 126, so that a process that suits the demand can be implemented.

Meanwhile, there may be a case where a high-accuracy analysis process is desired to be always performed for a specific semantic category 76 and/or a specific phrase type 75. For such a demand, an execution state value 82 corresponding to the combination of target semantic category 76 and phrase type 75 may be maintained at “PROCESS NOT DONE” for all the unit areas registered in processing state database 80 even when it should be updated to “PROCESS DONE”. By maintaining execution state value 82 at “PROCESS NOT DONE”, a report content 50 corresponding to the corresponding combination is analyzed by second analysis process program 128 or third analysis process program 130.

Further, the analysis process shown in FIG. 9 is repeatedly performed whenever a report content 50 is received; however, in addition to this, an additional analysis process may be performed afterwards. For example, when the number of report contents 50 received per unit time is decreased and the load state of analysis device 100 is reduced, reference may be made to an entry (processing state 81) of processing state database 80 to additionally process, by a higher-accuracy analysis process program pl (l>k), a report content 50 having been processed by an analysis process program pk. In other words, analysis device 100 may additionally perform an analysis process higher in accuracy than an analysis process used to obtain a processing result for any unit area 72. By additionally performing such an analysis process, a higher-accuracy and higher-quality processing result can be collected.

### H. EXEMPLARY APPLICATION

In the above description, the information collection at the time of disaster has been mainly illustratively described; however, it is not limited thereto and can be applied to any aspect in which a processing target including location information and a text must be processed efficiently.

For example, it can be applied to an aspect in which information from many participants participating in an event held in a wide range such as Olympic is efficiently collected.

### I. CONCLUSION

Information processing system 1 according to the present embodiment efficiently processes a report content 50 including location information and a text. That is, there is a need to highly accurately perform an analysis process for all the processing targets each including location information and a text; however, cost and processing time are required for such a high-accuracy analysis process. Therefore, when there are an enormous amount of processing targets, it is difficult to highly accurately process all the processing targets.

To address this, information processing system 1 according to the present embodiment optimizes the whole process by selecting a processing target and a processing content based on characteristics of location information. More specifically, based on the location information (unit area 72) and the semantic flag (phrase type 75 and semantic category 76) as a unit, information processing system 1 manages whether or not report content 50 is “PROCESS DONE” and manages the processing manner. Further, for a report content 50 (i.e., report content 50 estimated to be less likely to provide new information) for which information similar to the information already extracted is highly likely to be obtained with regard to the combination of the location information and the semantic flag, information processing system 1 completes the process only through a low-cost (i.e., low-accuracy) analysis process. By selecting the processing target in this way, a report content 50 regarding a unit area 72 for which no information has been obtained until then is preferentially processed at each point of time. In particular, for unit area 72 for which no information has been obtained, the high-accuracy analysis process is preferentially performed with a larger amount of cost. On the other hand, for a unit area 72 for which information has been already obtained, the cost required for the analysis process can be reduced.

As a result, the cost can be reduced as the whole process without significantly impairing usefulness of the information. In other words, not all of the enormous amount of report contents 50 are processed in real time and the order of priority of the processes is determined based on location information or the like, with the result that the analysis process is performed while maintaining balance between accuracy and processing speed.

The embodiments disclosed herein are illustrative and non-restrictive in any respect. The scope of the present invention is defined by the terms of the claims, rather than the embodiments described above, and is intended to include any modifications within the scope and meaning equivalent to the terms of the claims.

1.-6. (canceled)

7. An information processing system comprising:
a processing result database that stores a processing result of a processing target including location information and a text; and
one or more processors with a computer-readable program configured to:
determine a unit area corresponding to the location information included in the processing target,
analyze the text through an analysis process designated from among a plurality of analysis processes including a first analysis process and a second analysis process higher in accuracy than the first analysis process, and output the processing result,
when a processing result of another processing target for the determined unit area has been already stored after obtaining a first processing result by analyzing the text through the first analysis process, add the first processing result to the processing result database, and
when the processing result of the other processing target for the determined unit area has not been stored after obtaining the first processing result by analyzing the text through the first analysis process, obtain a second processing result by analyzing the text through the second analysis process and store the second processing result into the processing result database.

8. The information processing system according to claim 7, wherein
the plurality of analysis processes further comprises a third analysis process higher in accuracy than the first analysis process and lower in accuracy than the second analysis process, and
the one or more processors analyze, in a load state in which the second analysis process is unable to be performed, the text through the third analysis process instead of the second analysis process.

9. The information processing system according to claim 7, wherein the processing result includes a phrase that is a character string indicating information that should be extracted, and semantic information indicating a meaning of the phrase.

10. The information processing system according to claim 7, further comprising a processing state database that stores a processing state of an analysis process for each unit area, wherein
the processing state is settable to any one of a state in which an analysis process has been performed and a processing result has been obtained, a state in which an analysis process has been performed and no processing result has been obtained, and a state in which no analysis process has been performed yet.

11. The information processing system according to claim 7, wherein
the processing state includes information that specifies a type of the analysis process performed, and
the one or more processors additionally perform an analysis process higher in accuracy than the analysis process used to obtain the processing result of any unit area.

12. The information processing system according to claim 11, wherein
when the processing state of the determined unit area does not exist in the processing state database, the one or more processors search for a processing state for another unit area existing within a predetermined range from the determined unit area.

13. The information processing system according to claim 7, wherein the one or more processors obtain the second processing result by analyzing the text through the second analysis process even when the first processing result is unable to be obtained through the first analysis process.

14. The information processing system according to claim 7, wherein the location information include at least one of location information represented by latitude and latitude and location information represented by a UTM (Universal Transverse Mercator) coordinate system.

15. An information processing method comprising:
receiving a processing target including location information and a text;
determining a unit area corresponding to the location information included in the processing target;
obtaining a first processing result by analyzing the text through a first analysis process;
determining whether or not a processing result of another processing target for the determined unit area has been already stored in a processing result database;
when the processing result of the other processing target for the determined unit area has been already stored in the processing result database, adding the first processing result to the processing result database; and
when the processing result of the other processing target for the determined unit area has not been stored in the processing result database, obtaining a second processing result by analyzing the text through a second analysis process higher in accuracy than the first analysis process, and storing the second processing result into the processing result database.

16. The information processing method according to claim 15, wherein
the plurality of analysis processes further comprises a third analysis process higher in accuracy than the first analysis process and lower in accuracy than the second analysis process, and
the method further comprises analyzing, in a load state in which the second analysis process is unable to be performed, the text through the third analysis process instead of the second analysis process.

17. The information processing method according to claim 16, wherein the processing result includes a phrase that is a character string indicating information that should be extracted, and semantic information indicating a meaning of the phrase.

18. The information processing method according to claim 16, further comprising providing a processing state database that stores a processing state of an analysis process for each unit area, wherein
the processing state is settable to any one of a state in which an analysis process has been performed and a processing result has been obtained, a state in which an analysis process has been performed and no processing result has been obtained, and a state in which no analysis process has been performed yet.

19. The information processing method according to claim 18, wherein
the processing state includes information that specifies a type of the analysis process performed, and
the method further comprises additionally performing an analysis process higher in accuracy than the analysis process used to obtain the processing result of any unit area.

20. The information processing method according to claim 16, further comprising, when the processing state of the determined unit area does not exist in the processing state database, searching for a processing state for another unit area existing within a predetermined range from the determined unit area.

21. The information processing method according to claim 16, further comprising obtaining the second processing result by analyzing the text through the second analysis process even when the first processing result is unable to be obtained through the first analysis process.

22. The information processing method according to claim 16, wherein the location information include at least one of location information represented by latitude and latitude and location information represented by a UTM (Universal Transverse Mercator) coordinate system.

23. A non-transitory storage medium storing an information processing program thereon, the information processing program, when executed by one or more processors, causes the one or more processors to perform:
receiving a processing target including location information and a text;
determining a unit area corresponding to the location information included in the processing target;
obtaining a first processing result by analyzing the text through a first analysis process;
determining whether or not a processing result of another processing target for the determined unit area has been already stored in a processing result database;
when the processing result of the other processing target for the determined unit area has been already stored in the processing result database, adding the first processing result to the processing result database; and
when the processing result of the other processing target for the determined unit area has not been stored in the processing result database, obtaining a second processing result by analyzing the text through a second analysis process higher in accuracy than the first analysis process, and storing the second processing result into the processing result database.

24. The non-transitory storage medium according to claim 23, wherein
the plurality of analysis processes further comprises a third analysis process higher in accuracy than the first analysis process and lower in accuracy than the second analysis process, and
the information processing program further causes the one or more processors to perform analyzing, in a load state in which the second analysis process is unable to be performed, the text through the third analysis process instead of the second analysis process.

25. The non-transitory storage medium according to claim 23, wherein the processing result includes a phrase that is a character string indicating information that should be extracted, and semantic information indicating a meaning of the phrase.

26. The non-transitory storage medium according to claim 23, wherein
the information processing program further causes the one or more processors to perform providing a processing state database that stores a processing state of an analysis process for each unit area, wherein
the processing state is settable to any one of a state in which an analysis process has been performed and a processing result has been obtained, a state in which an analysis process has been performed and no processing result has been obtained, and a state in which no analysis process has been performed yet.
